(19) United States
(12) Patent Application Publication
(10) Pub. No.: US 2008/0320037 A1
(43) Pub. Date: Dec. 25, 2008

(54) System, method and apparatus for tagging and processing multimedia content with the physical/emotional states of authors and users

(76) Inventors: Sean Michael MacGuire, Beaconsfield (CA); Sylvio Drouin, San Francisco, CA (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/151,227

(22) Filed: May 5, 2008

Related U.S. Application Data
(60) Provisional application No. 60/916,162, filed on May 4, 2007.

(51) Int. Cl. G06F 17/30

(52) U.S. Cl. 707/103 R; 707/E17.009

(57) ABSTRACT

A system, method and apparatus which enables the tagging of multimedia content with the physical and emotional states of authors and users thereby making it searchable by emotion or physical state.

### CROSS-REFERENCE TO RELATED APPLICATIONS

This Application claims priority on U.S. Provisional Patent Application No. 60/916,162 filed on May 4, 2007, currently pending, which is herein incorporated by reference.

### FIELD OF THE INVENTION

The current invention relates to multimedia metadata, and more particularly, to a system, method and apparatus for the tagging and processing of multimedia content with the physical and emotional states of authors and users.

### BACKGROUND OF THE INVENTION

It is known that it is difficult to effectively search multimedia archives, without extensive pre-processing. For example, there are few if any systems which would produce useful, consistent and effective results for a search for a “girl in green dress” [http://video.google.ca/videosearch?q=girl+in+green+dress], without these specific keywords being associated with the video during the creation of the search archive.

It is likewise known that humans are still the best means of providing useful descriptions of the contents of a multimedia file.

It is also known that humans are emotional. Some more than others. However, aside from direct interpretation of the content of multimedia by a human, there are currently very limited ways for humans to describe or tag content with particular emotions.

One of the common methods of tagging content with an emotion is through the use of an ‘emoticon’ such as a smiley face commonly denoted by the symbol: in text. A method for sending multimedia messages with emoticons is disclosed by Joern Ostermann in >U.S. Pat. No. 6,990,452. Another method known as emotagging allows writers to enter an emotion in text using an tag similar to those used in Hypertext Markup Language HTML as defined here http://computing-dictionary.thefreedictionary.com/emotag, or as used in the following sentence: “<SMIRK>These inventors really have a great sense of humor </SMIRK>.”

However, these are generally used only in chats or e-mail, and are generally limited to adding amusing effects or identifying commentary in such a way that the recipient doesn't take offense. There currently exists no generalized means of tagging content with the emotions of either the creator of the content, or the consumers thereof.

In addition, although it would appear obvious that a person's physical state has a clear influence on their emotional state, the implications of this connection have rarely been considered. One relatively well-known exception to this is in the addiction-recovery community which has uses the acronym “H.A.L.T.” warning those in recovery against getting too hungry, angry, lonely, or tired http://www.recoverysolutionsmag.com/issue_v1_e2_h2.asp; thus to get a more accurate picture of the emotional state, some idea of the physical state would be helpful.

The ability to add physical and emotional tags, or phemotags, to content has important ramifications. With this capability users can now search content by emotion, and this content can be analyzed empirically using these phemotags. In addition there are important security implications, for example users could search for “rage” phemotags on sites like MySpace.com® to identify potentially violent people or situations, or identify phemotags that “don't fit” such as “joy” phemotags attached to multimedia about terrorist attacks against the United States. In addition, providing additional physical state context along with the emotional state would allow additional searches by physical situations, such as users who are sick, in pain, or not sober.

Therefore the need has arisen for a system, method and apparatus which allows users to tag and rate multimedia documents with a description of their current physical and emotional states combined with a system which then processes these tags and allows this multimedia to be searched by these physical and emotional metatags.

### SUMMARY OF THE INVENTION

It is an object of the present invention to create a rating system which provides a comprehensive, simple, and empirical means of measuring current physical and emotional states.

It is a further object of the present invention to provide a comprehensive input mechanism for the system above which multimedia authors may use to record their current physical and emotional states and associate it with the content they create.

It is a further object of the present invention to provide an efficient input mechanism based on the rating system above by which readers can record their reactions to multimedia.

It is a further object of the present invention to provide a means of collecting and aggregating these measurements in order to be able to perform searches, calculations, trending and analysis of the tagged content, and by extension, its authors.

Therefore, in accordance with the present invention, there is provided a method of tagging multimedia contents comprising: identifying a multimedia content; selecting at least one of a physical state and an emotional state; and associating the at least one of a physical state and an emotional state with a multimedia content.

Also in accordance with the present invention, there is provided a machine-readable media having machine readable instructions providing a method of tagging multimedia content, the method comprising: identifying a multimedia content; selecting at least one of a physical state and an emotional state; and associating the at least one of a physical state and an emotional state with the multimedia content.

Further in accordance with the present invention, there is provided an apparatus for tagging multimedia content, the apparatus comprising: a tagger module adapted to request that a multimedia content be tagged; a record module, in communication with the tagger module, adapted to record metadata regarding the multimedia content; a state module, in communication with the record module, adapted to process the selection of at least one of a physical state and an emotional state of the multimedia content, the selection of the at least one of a physical state and an emotional state being stored in the record module; and an association module adapted to associate the selection of the at least one of a physical state and an emotional state with the multimedia content.

Other objects/aspects of the present invention will become apparent to a skilled reader in the art of multimedia content creation in view of the following description and the appended figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features of the invention will become more apparent in the following detailed description in which reference is made to the appended drawings wherein:

FIG. 1 is a table of emotions and some of the physical states which affect them;

FIG. 2 is a schematic of an exemplary user interface for authors to use to tag their content;

FIG. 3 is a schematic of an exemplary user interface for users to rate content;

FIG. 4 is a block diagram detailing how physical/emotional metadata is processed; and

FIG. 5 is a color icon illustrated in both normal and magnified sizes.

### DETAILED DESCRIPTION OF THE INVENTION

This invention allows authors to provide relatively detailed information about their emotional and physical states associated with a piece of multimedia. It also provides a mechanism for empirically identifying and measuring these emotions, along with the ability to perform searches, calculations, trending and analysis of this emotional and physical data. An interesting side effect is the use of such a system for personal video diary entries. By using this system on diary entries it would become possible to graph a person's emotional and physical states over time in a relatively controlled and accurate manner, which could have very important therapeutic benefits.

This invention is an important enhancement in multimedia because until now the only way to associate emotion with a piece was by personal experience—to watch it and interpret the contents; and even once this was done, there was no standardized way to record and share the results with others, nor could this important information be amalgamated, processed or searched. Thus it provides a mechanism for consumers of multimedia to provide relatively detailed information about their emotional reaction to a multimedia piece, effectively a different, more human, kind of rating.

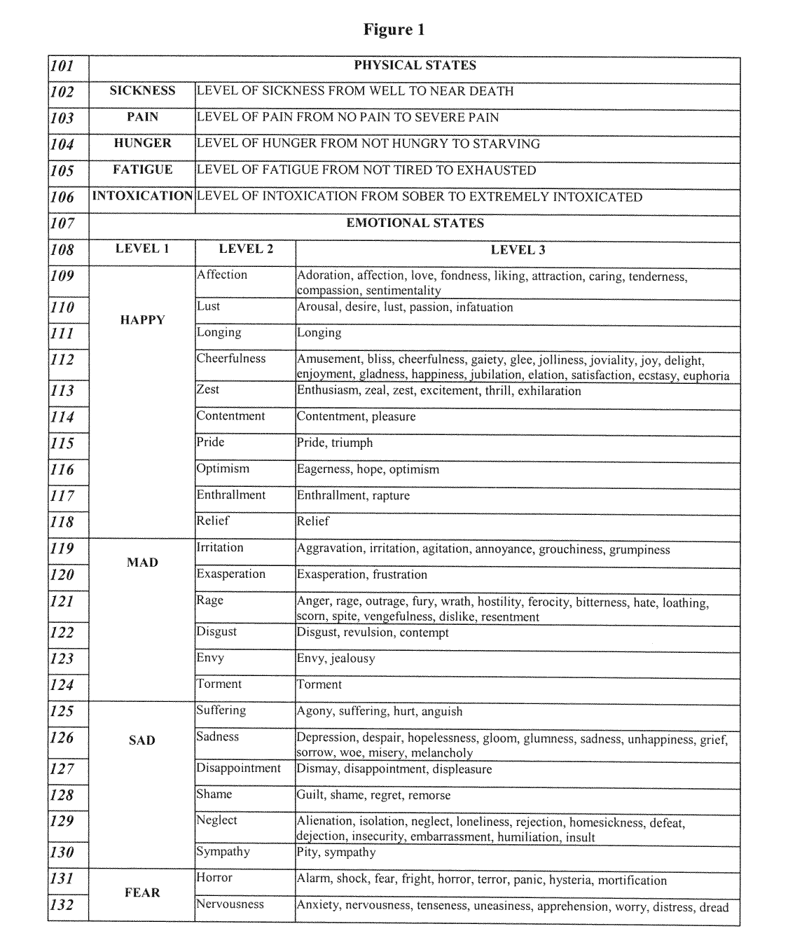

Turning now to FIG. 1, a table of physical states and emotions is shown. This list names the states we are measuring. We begin with basic physical states 101-106 which affect the emotional states. We measure sickness 102 and pain 103, since these have an obvious effect on emotions. We then we ask about hunger 104 and fatigue 105 since these states can have a strong influence on emotions but are frequently overlooked. Finally we ask about being intoxicated 106, since that has an extraordinary impact on emotions, positively, negatively, and randomly.

Next we list a variety of emotional states 107. This part of the table is almost identical to that found in Parrott, W. 2001, Emotions in Social Psychology, Psychology Press, Philadelphia which is incorporated herein by reference. The important element of this table is that it divides emotions into 3 levels, Level 1, Level 2, and Level 3 108; and emotions themselves are divided into 4 basic categories: Happy 109-118, Mad 119-124, Sad 125-130, and Fear 131, 132.

Thus, the tagging system is based on identifying a user's physical states using the categories 102-106, and rating each state using an empirical scale of some sort, i.e. a scale of 0 to 10, 10 being the most intense. Therefore the users emotional states are tagged by selecting the emotion from the categories 109-132 at any level, and rating it using an empirical scale, i.e. a scale from 1 to 10, 10 being the most intense. Of course, this terms used in this table could be changed, likewise the levels, etc, but the principle being the use of a table of terms, within different levels, combined with an indicator of the intensity of that emotion using a scale of some sort.

As a self-referencing example, I can use this table to tag my current state writing this patent application: SICK=0, PAIN=0, HUNGER=0, FATIGUE=4, INTOXICATION=0. Emotionally the tags are HAPPY=6, IRRITATION=3. This means I'm a little tired, pretty happy, and mildly irritated because patent specifications are difficult and painstaking to write.

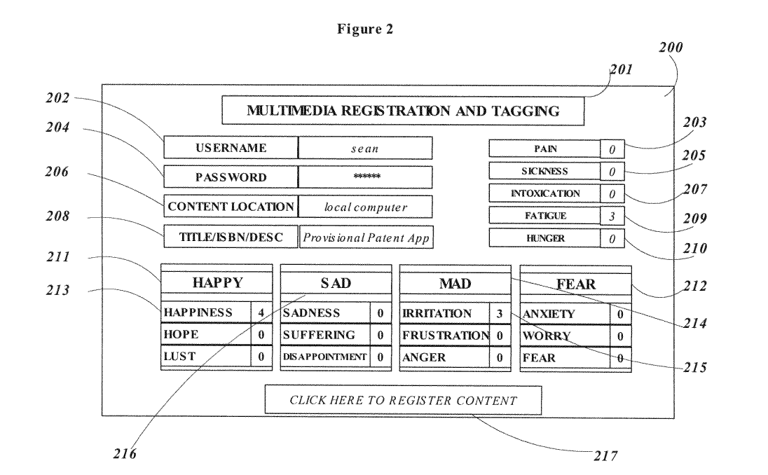

Referring now to FIG. 2, this is an illustrative schematic of the user interface for authors to use in tagging their multimedia content 200. We will assume that this interface is provided online via a web interface using a computer connected to the internet. We will likewise assume that the content being tagged is available and accessible via the internet, although it doesn't necessarily have to be.

The page displays the title 201, and requires a username 202 and a password 204 to be able to register content. Obviously a system that tracks emotions associated with the production of multimedia content will need to be able to positively identify authors, since this is sensitive information, it needs to be secured. Since it is also intimately associated with identity, it's important that authors be pre-authorized to use the system, and be granted a username and password to be able to access the information therein. Other means of registration and access may be used as well provided they provide sufficient security for users of the system.

The author notes the location where the content is located 206, this will usually be a Universal Resource Locator URL, but doesn't have to be. In addition, the author provides the title of the work, an ISBN number if available, and description 208. Other information may likewise be added if desired.

The author now asks himself about his level of pain 203, sickness 205, intoxication 207, fatigue 209, and hunger 210. We see our author is a little tired, having entered ‘3’ as their current level of fatigue. Physical states are entered as numbers between 0-10 in our example, but other scales and input methods may be used. In addition the list of physical states may be expanded or modified if desired as well.

Next, the author analyzes their current emotional state, under the general headings of HAPPY 211, SAD 216, MAD 214 and FEAR 212. These headings correspond to the headings shown in FIG. 1. These headings are further subdivided into 3 sub-sections each, corresponding to the emotions described in the Level 2 column of FIG. 1 108. In our example, our author is mildly happy, having entered 4 for HAPPINESS 213, and is slightly irritated, having entered 3 for IRRITATION 215.

Finally to register their content, the author hits the “Click here to register content” button 217, and the selected list of emotions and values is transmitted to a central location where it is processed. For the sake of simplicity, the emotions are transmitted by simply listing the name of the emotion as found in FIG. 1 and on the form, a separator, and the intensity of the emotion from 0-10; thus in our example the following would have been transmitted: HAPPINESS:4, IRRITATION:3 along with all the identifying information for the author and work being registered.

Note that the actual registration process may be handled in many different ways, from an online form directly connected to a server on the Internet, to printing out the form and mailing it into a central location where it is processed manually and entered into a system for processing this type of information.

This list of emotions could be expanded to include every emotion listed in FIG. 1, however for the registration of simple multimedia the list in FIG. 2 is probably sufficient as a balance between accuracy and simplicity. However, should the multimedia be a personal diary-type application, for personal or therapeutic use, or if the users are teenage girls or others highly interested in their own emotional nuances, then the list of emotions to choose from should probably be expanded. All this to say that the list of emotions can be modified as necessary, however the emotions chosen should either already exist or be added to the list of emotions in FIG. 1, as this table will be used later to map the emotions into a form better suited to empirical analysis.

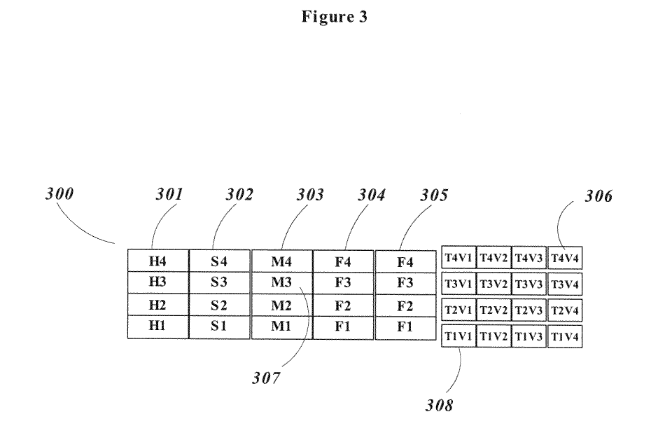

Referring now to FIG. 3, this is the schematic of the user interface used by consumers of multimedia 300. The preferred embodiment of this interface is as an icon located at the bottom of multimedia to be rated, as on a web page, and to allow users to use a mouse-like pointing device to click on the various areas to rate the content according to a variety of criteria, as such it must be unobtrusive, simple to understand and easy and quick to use.

The interface has two main areas, the emotional rating area 301-305 and the quality- value matrix 306,307. The emotional rating area is divided into four columns, each column corresponding to one of the Level 1 Emotions listed in FIG. 1 108. Each column is then further subdivided into four levels, numbered 1-4 from the bottom. The columns rate HAPPY 301, SAD 302, MAD 303, and FEAR 304 from 1-4. Thus a user who was felt pretty mad about a piece of multimedia would click the near the top of the third column M3 307.

Note that in Figure three letters and numbers were used to denote the emotions and the relative values; the preferred embodiment of this interface is a small icon using color to represent the measured emotions, namely green for HAPPY, blue for SAD, red for MAD, yellow for FEAR with the intensity of the color going from darker to lighter from the bottom of the column to the top. This color code is important as it is relatively mnemonic—that there are already strong sociological connections between blue for SAD, red for MAD, and yellow for FEAR, thus making the interface extremely intuitive and easy to use.

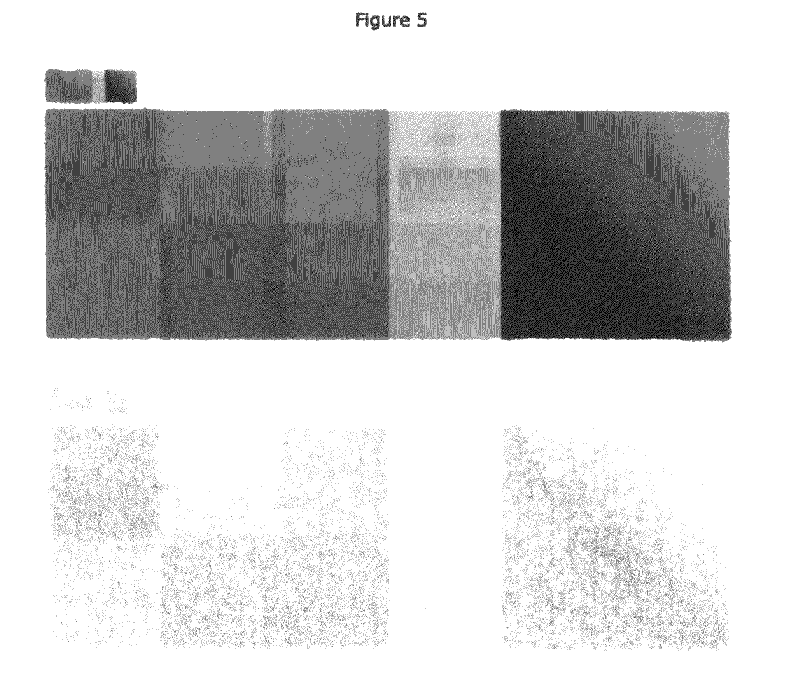

The second main area 310 of the interface is a 4×4 grid. This grid measures trust along the Y axis, and value along the X axis, again from one to four. Therefore if a user trusts the source of the multimedia and believes the content has value, they would click in the top right-hand corner of the grid T4V4 306. If however, they thought the article was lousy and from a disreputable source, they would just click the bottom-left hand corner of the grid T1V1 308. Similar to the emotional measurements, each grid square has a value associated with it which will be used as the empirical representation of the qualities being measured. Note that the preferred embodiment of this part of the interface is a gradient going from black at T1V1 to magenta at T4V4. An actual copy of the illustrative icon in color is shown at FIG. 5.

Still referring to FIG. 3, an important quality of this interface is that users can measure multiple emotional states by simply clicking in the appropriate columns at the appropriate levels; in fact with this design, four emotions plus trust and value can be measured, with five mouse-clicks. However, users are free to measure what they want to, some may just want to rate quality/value, others may only have a single emotion to report.

Note that this interface may be implemented in a variety of ways, using different colors, scales, sizes, and technologies; emotions may be added, changed or deleted as desired. Adding another emotion would simply involve adding an extra column to the interface above. Note that the only Level 1 emotion we could still add is “Surprise” which Parrott has in his original chart, which we removed because it tends to be fleeting and difficult to categorize. This interface could even be used in newspapers - with the user using a pencil or pen to place an X in the appropriate columns, with the user then cutting the story out and mailing the story and rating back to the newspaper. It may not be practicable, but it is nonetheless possible and is included here for completeness.

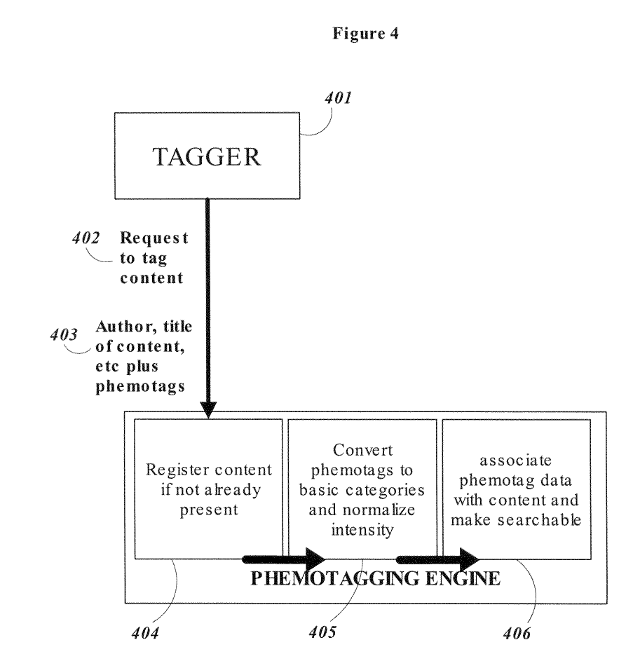

Turning now to FIG. 4, this is a block diagram detailing how physical and emotional metadata is processed. The first step is that the user uses a tagger 401 such as described in FIGS. 2 and 3 to request that some multimedia content be tagged 402. The physical and emotional metadata is then transmitted to the phemotagging engine 403.

If the engine does not already know about this content, the content is registered, and a record is created for it containing information such as the title, author, and location which was provided as part of the tagging request.

Once the content is registered, the physical and emotional data is then processed. The physical information provided Pain 203, Sickness 205, Intoxication 207, Fatigue 209, and Hunger 210, do not need special treatment aside from normalizing them using an intensity on a scale of 0-100. Likewise our measurements of Trust and Value 309 only need their intensity normalized. Each of these values is then assigned to variables corresponding to the states above, i.e. PAIN, SICKNESS, INTOXICATION, FATIGUE, HUNGER, TRUST and VALUE.

Next, each emotion listed in FIG. 1 is available as a variable for assignment. The intensity values associated with each emotion is first normalized on a scale of 0-100, and then assigned to the variable of that name. For example our rating of M3 307 would be translated as follows, M=MAD, and use the halfway point in the third level 50+75/2=63, therefore MAD=63.

The emotional data requires additional processing to map emotions from Levels 3 onto Level 2 and again onto Level 1 to enable searches of arbitrary emotional precision. For example, if we received a tag of the emotion of JOY at level 10 out of 10, we would normalize the intensity to equal 100, so JOY=100. However only people searching for JOY would find this record. People searching for HAPPINESS wouldn't see it unless it was mapped. Therefore we map Level 3 emotions onto Level 2, so a record of HAPPINESS=100 would also be associated with the multimedia. Similarly HAPPINESS isn't quite the same as our Level 1 emotion of HAPPY, so would create a record of HAPPY=100 to be associated as well. In this manner, someone searching for a very happy story using HAPPY>90 or HAPPINESS >90 or JOY>90 would all find our tagged story. We then add these additional mappings to our multimedia record 406.

And because we permit multiple emotions to be tagged, we're presented the problem of how to handle the mapping of multiply tagged emotions being mapped to another level. For example if we were to receive JOY=5 and SATISFACTION=10 how would something like that be handled? In mapping we would just normalize the levels so we'd have JOY=50 and SATISFACTION=100, and map the maximum value of all emotions within a given level to the next level up, i.e. HAPPINESS=100 which in turn would map to HAPPY=100. Similarly we can map Level 2 emotions onto Level 1 in the same manner by using the maximum intensity. In this manner, if someone was searching for HAPPY>90, they would find our record, however if they were searching for JOY>90, they wouldn't, since the declared level of JOY was only 50.

Therefore to summarize, if one or more Level 3 emotions is tagged, they must be mapped onto the equivalent Level 2 emotion using by choosing the highest value tagged, i.e. maxLevel3. If one or more Level 2 emotions are tagged, or generated via a mapping, they must be mapped onto a Level 1 emotion in the same manner of maxLevel2. So every piece of tagged multimedia ends up with a Level 1 mapping of the emotions tagged therein.

It is now clear that having assigned normalized values to a variety of emotions, and having normalized the emotions themselves, we may now perform arbitrary searches and calculations on our rated content. It would now be simple to find the happiest piece of multimedia, or the one which aroused the most anger. Similarly, if we know the authors of the content, we can now determine which authors make people the most happy, mad, sad and afraid, and because the authors themselves can rate their states, we can find the ones that are happiest, most depressed, or most intoxicated. In fact, we could now even provide trends, and see authors emotional trends—becoming more happy, depressed, angry, etc. This is powerful empirical information with great therapeutic possibilities.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A method of tagging multimedia contents comprising:
identifying a multimedia content;
selecting at least one of a physical state and an emotional state; and
associating the at least one of a physical state and an emotional state with a multimedia content.

2. The method of claim 1, wherein the selection of at least one of a physical state and an emotional state comprises a quantification of the selected state.

3. The method of claim 2, wherein the quantification is normalized.

4. The method of claim 1, wherein at least one of the physical state and the emotional state have a first level of state and a second level of state, the quantification of the first level of state using the higher quantification of the second level of state when the second level of state is quantified higher than the quantification of the first level of state.

5. The method of claim 1, wherein the physical state is selected from the group consisting of sickness, pain, hunger, fatigue and intoxication.

6. The method of claim 5, wherein the physical state is further divided into a plurality of physical sub-states.

7. The method of claim 1, wherein the emotional state is selected from the group consisting of happiness, pain, hunger, fatigue and intoxication.

8. The method of claim 7, wherein the emotional state is further divided into a plurality of emotional sub-states.

9. The method of claim 1, comprising:
displaying at least one of a physical state and an emotional state in a rating user interface;
displaying a quality-value rating user interface; and
receiving an instruction based on a selection of a rating displayed on at least one of the interfaces.

10. The method of claim 9, wherein at least one of the rating user interfaces use a color-coded rating.

11. A machine-readable media having machine readable instructions providing a method of tagging multimedia content, the method comprising:
identifying a multimedia content;
selecting at least one of a physical state and an emotional state; and,
associating the at least one of a physical state and an emotional state with the multimedia content.

12. The machine-readable media having machine readable instructions providing the method of claim 11, wherein the selection of at least one of a physical state and an emotional state comprises a quantification of the selected state.

13. The machine-readable media having machine readable instructions providing the method of claim 12, wherein the quantification is normalized.

14. The machine-readable media having machine readable instructions providing the method of claim 11, wherein at least one of the physical state and the emotional state have a first level of state and a second level of state, the quantification of the first level of state using the higher quantification of the second level of state when the second level of state is quantified higher than the quantification of the first level of state.

15. The machine-readable media having machine readable instructions providing the method of claim 11, wherein the physical state is selected from the group consisting of sickness, pain, hunger, fatigue and intoxication, wherein at least one of the physical state is further divided into a plurality of physical sub-states, wherein the emotional state is selected from the group consisting of happiness, pain, hunger, fatigue and intoxication and wherein at least one of the emotional state is further divided into a plurality of emotional sub-states.

16. The machine-readable media having machine readable instructions providing the method of claim 11, comprising:
displaying at least one of a physical state and an emotional state in a rating user interface;
displaying a quality-value rating user interface; and,
receiving an instruction based on a selection of a rating displayed on at least one of the interfaces.

17. The machine-readable media having machine readable instructions providing the method of claim 16, wherein at least one of the rating user interfaces uses a color-coded rating.

18. An apparatus for tagging multimedia content, the apparatus comprising:
a tagger module adapted to request that a multimedia content be tagged;
a record module, in communication with the tagger module, adapted to record metadata regarding the multimedia content;
a state module, in communication with the record module, adapted to process the selection of at least one of a physical state and an emotional state of the multimedia content, the selection of the at least one of a physical state and an emotional state being stored in the record module; and,
an association module adapted to associate the selection of the at least one of a physical state and an emotional state with the multimedia content.

19. The apparatus for tagging multimedia content of claim 18, comprising a user-selectable interface displaying at least one of the physical state and the emotional state, the user-selectable interface being adapted to receive instructions about the selected state.

20. The apparatus for tagging multimedia content of claim 19, wherein the user-selectable interface defines a region associated with a color associated with a state, a selection of the colored region selecting the state associated therewith.
